(19) United States
(12) Patent Application Publication
(10) Pub. No.: US 2002/0044321 A1
(43) Pub. Date: Apr. 18, 2002

(54) Infrared radiation remote control system for a portable computer

(76) Inventors: Yu-Cheng Hua, Taipei Hsien (TW); Chun-Liang Chen, Taipei Hsien (TW); Te-Yu Liang, Taipei Hsien (TW)

Correspondence Address: Michael D. Bednarek, SHAWPITTMAN, 1650 Tysons Boulevard, McLean, VA, 22102-4859, US

(21) Appl. No.: 09/814,775

(22) Filed: Mar. 23, 2001

(30) Foreign Application Priority Data
Oct. 17, 2000 (TW) 089122019

(51) Int. Cl. H04B 10/00; H04B 10/06

(52) U.S. Cl. 359/142; 359/189

(57) ABSTRACT

A remote control system for a portable computer with a built-in IR receiver receiving IR signals emitted from a remote controller, comprising chipsets connecting the central processing unit to the IR receiver and to a serial port; a circuit switcheably connecting the IR receiver to the serial port; and software for determining whether to switch short the circuit by transmitting a first signal to the circuit and whether to switch open the circuit by transmitting a second signal to the circuit. The IR receiver is connected to the central processing unit through a FIR port; the first signal represents a switch from digit 0 to digit 1 of a particular pin of the circuit, while the second signal represents a switch from digit 1 to digit 0 of the same pin of the circuit; CIR signals received by the IR receiver are further transmitted to and received by the central processing unit through the serial port when the software switches short the circuit connecting the IR receiver to the serial port by transmitting the first signal to the circuit. Accordingly, the present invention allows the computer to receive, and thereby to be remotely controlled by, two differently encoded IR remote control signals, namely, FIR and CIR, with only one IR receiver.

### REFERENCE TO RELATED APPLICATIONS

The present application claims priority to Taiwan application NO. 089122019 entitled “Remote control system” filed on Oct. 17, 2000.

### BACKGROUND OF THE INVENTION

1. Field of the Invention

The present invention relates to a remote control system for a computer. More particularly, it relates to an infrared radiation remote control system for controlling and instructing within a distance a portable computer to perform particular tasks.

2. Description of the Related Art

It is known that IR (infrared radiation) remote controllers have, for their compactness and ease of use, become required accessories of household appliances such as TV sets and stereos. IR remote controllers can be categorized according to their implementations into two systems: consumer IR (CIR) system and Fast IR (FIR) system. Whereas CIR is economical, with a short control range, FIR is more costly, but with a rather long control range. The cost and effective control range are to be weighted against each other in light of the appliances concerned and operating conditions involved so that the manufacturer can choose which system is to be utilized. For general household appliances, it is CIR that is commonly utilized.

In the field of information appliances (IA), portable computers implemented with IR remote control functionality are becoming popular. For the reason that CIR and FIR are of different encoding methods, it is practiced in the prior art that, for a computer to receive and decode accordingly both CIR and FIR signals, distinct ports of the central processing unit (CPU) are dedicated respectively to distinctly encoded signals. Generally, FIR signals are received by the CPU through a dedicated FIR port, and CIR signals through a serial port. In such case, a computer is able to receive and subsequently decode both CIR signals and FIR signals only when the computer is accompanied with two separate IR receivers through each of which respectively CIR signals and FIR signals are received and subsequently transferred to the corresponding ports dedicated to their reception.

### SUMMARY OF THE INVENTION

As described above, for a portable computer to process both CIR and FIR signals according to prior art, two IR receivers are required for their reception. Under such circumstances that both or one of the IR receivers is not integrated into the portable computer and is externally connected to it, the IR receiver(s) and connection wire(s) may lessen the portability of the portable computer, thus contradicting the original object of the entire system for its compactness and advantages.

In order to overcome the problem accordingly, the inventor has devised a computer system within which a single IR receiver is installed for receiving both CIR and FIR signals.

The object of present invention is to provide a computer system with an IR remote controller, wherein CIR signals and FIR signals of different encoding techniques are received by a single receiver mounted on the computer.

Another object of the present invention is to provide a circuit connecting the FIR port and serial port which serves as a short/open switch between the ports so as to make it possible that CIR signals and FIR signals of different encoding techniques are received by a single receiver mounted on the computer.

Still another object of present invention is to provide control software at the command of the user to activate or deactivate the CIR remote control system for the portable computer.

Still another object of present invention is to provide a CIR remote controller for controlling at a distance from the portable computer the functions of pageup and pagedown of the keyboard.

Another object of present invention is to provide a single IR receiver built into the portable computer for receiving CIR and FIR signals of different encoding techniques, with advantages of being more compact and portable compared to the prior art.

### BRIEF DESCRIPTION OF THE DRAWINGS

The following detailed description, which is given by way of example, and not intended to limit the invention to the embodiments described herein, can best be understood in conjunction with the accompanying drawings, in which:

FIG. 1 illustrates the IR remote control system for a portable computer according to the prior art.

FIG. 2 illustrates the schematic diagram of the IR remote control system for a portable computer according to the prior art.

FIG. 3 illustrates an IR remote control system for a portable computer according to the present invention.

FIG. 4 illustrates a schematic diagram of the IR remote control system for a portable computer according to the present invention.

FIG. 5 illustrates a switch circuit diagram according to the present invention.

FIG. 6 illustrates a flow chart of the control software of the IR remote control system for a portable computer according to the present invention, wherein

FIG. 6(a) is the flow chart of a main program, and

FIG. 6(b) is a monitor subprogram.

### DETAILED DESCRIPTION OF THE INVENTION

Though the following detailed description pertains to one particular embodiment wherein a laptop computer is equipped with one IR receiver receiving remote control signals from a CIR remote controller so as to perform pageup and pagedown accordingly, it is to be understood that the present invention can be embodied in different computer systems such as mobile phones, personal digital assistants (PDA), webpads, or other information appliances and portable electronics with remote controllers, as well as into different control functions other than turning pages, such as switching windows, initializing a particular program, or shutting down hardware.

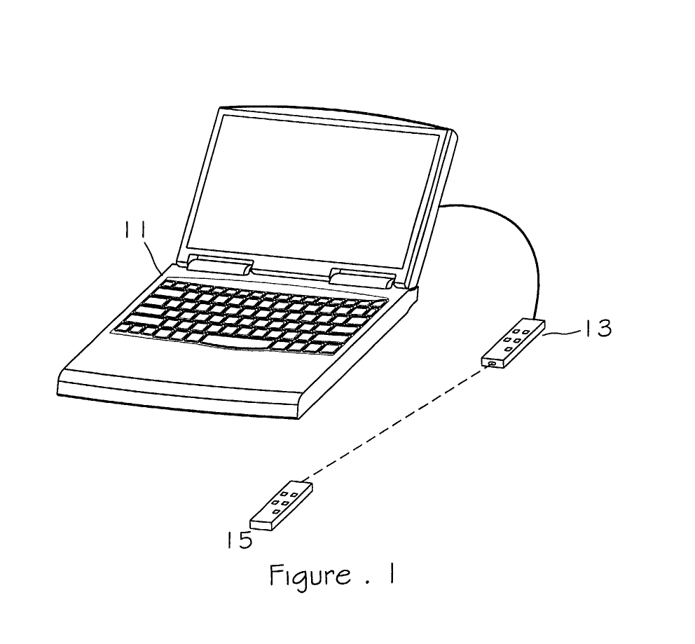

FIG. 1 illustrates the IR remote control system for a portable computer according to the prior art. IR receiver 13 is connected to laptop computer 11 through a serial port mounted at the back end of laptop computer 11. CIR remote controller 15 transmits CIR control signals that are received and converted into corresponding electrical signals by IR receiver 13. The electrical signals are further transmitted by IR receiver 13 to laptop computer 11 through the serial port connecting IR receiver 13 to laptop computer 11. After receiving the signals, laptop computer 11 turns the document in display to a previous page or a next page accordingly. Typically, CIR remote controller 15 can function properly up to several meters surrounding IR receiver 13.

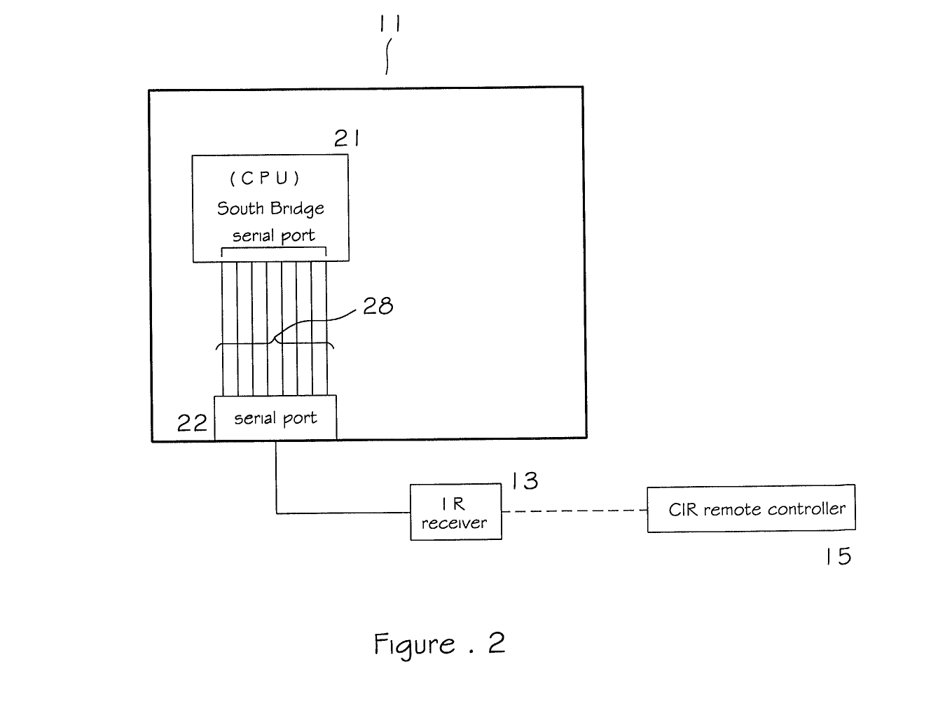

FIG. 2 illustrates the schematic diagram of the IR remote control system for a portable computer according to the prior art. Laptop computer 11 comprises serial port 22 communicating between (CPU) south bridge 21 and IR receiver 13. IR receiver 13 receives CIR control signals transmitted by CIR remote controller 15 and, after converting the received CIR control signals into electrical signals, transmits the signals through serial port 22 and serial port bus 28 to south bridge 21. Subsequently, after receiving the signals via south bridge 21, the CPU proceeds to turn the document in display to a previous page or a next page accordingly.

As noted above, the separation of IR receiver 13 and laptop computer 11 as two separate apparatuses connected through wires according to the prior art causes problems concerning the portability of the whole system. Moreover, under such arrangement, IR receiver 13 serves only for reception of the CIR signals transmitted by CIR remote controller 15 so that if one desires to add FIR remote control function to laptop computer 11, one has to install thereon another IR receiver for reception of FIR signals simply due to the fact that FIR signals are processed by CPU through a dedicated FIR port, and CIR signals through the serial port. In such case, a portable computer system with two externally connected IR receivers makes itself inconvenient to manage, as well as less portable. These are the difficulties of the prior art that the present invention is to overcome.

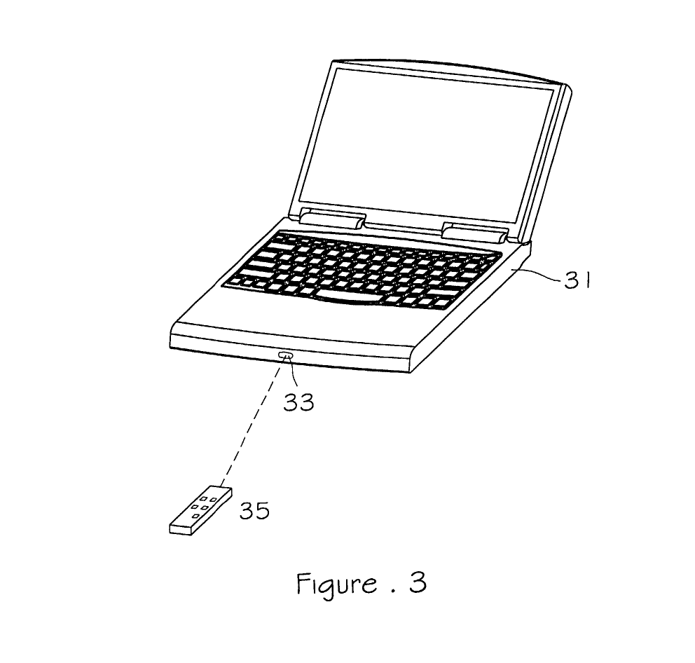

FIG. 3 illustrates the IR remote control system for a portable computer according to the present invention. IR receiver, instead of connecting to laptop computer 31 externally via wires, is installed on the front end of laptop computer 31 for reception of CIR signals emitted from CIR remote controller 35 and of FIR signals, thus avoiding the problem arising from the connecting wires according to prior art.

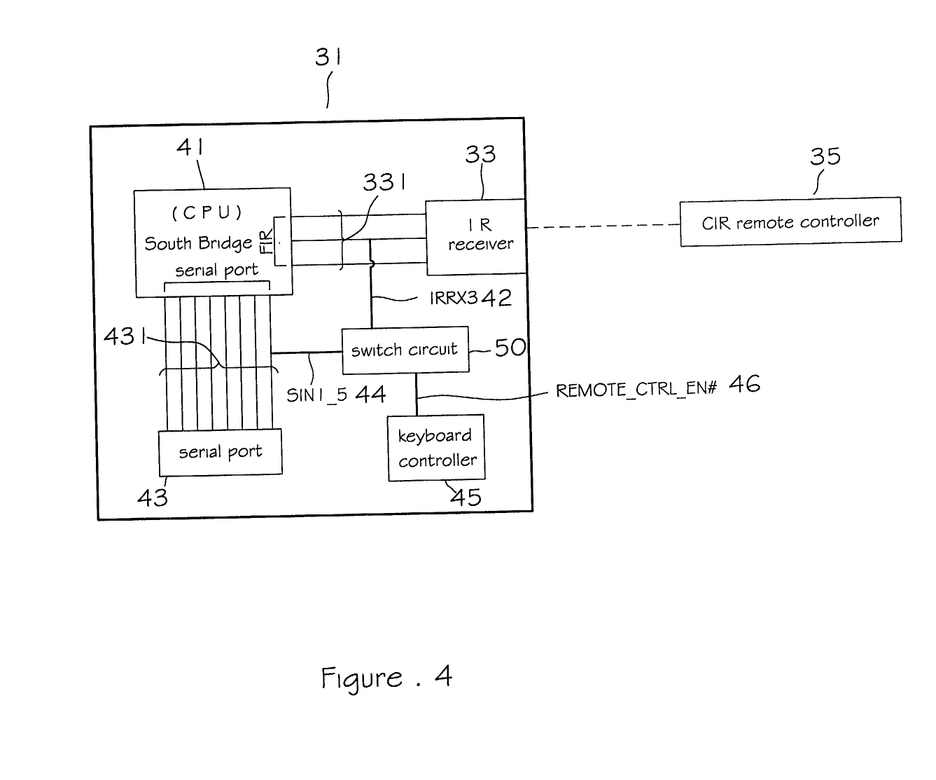

FIG. 4 illustrates the schematic diagram of the IR remote control system for a portable computer according to the present invention. Laptop computer 31 comprises serial port 43 connecting to south bridge 41 through serial port bus 431, IR receiver 33 connecting to south bridge 41 through FIR port bus 331, and a keyboard controller 45. Moreover, laptop computer further comprises switch circuit 50 connecting to keyboard controller 45, one particular pin of serial port 43, and one particular pin of FIR port 33. It is understood by those skilled in the art that the aforementioned connections require certain chipsets mounted on the motherboard of laptop computer 31.

The spirit of the present invention lies in utilizing one single IR receiver 33 for reception of FIR and CIR remote control signals and channeling the signals via switch circuit 50 to appropriate ports of the CPU for processing according to their encoding techniques. In the embodiment of present invention, FIR remote control signals received by the IR receiver 33 are channeled directly to FIR port of the CPU, while CIR remote control signals received by the IR receiver 33 are to be channeled to serial port 43 via switch circuit 50.

Referring to FIG. 4, IRRX3 pin 42 is one particular pin of FIR port; SIN1_{—}5 pin 44 is one particular pin of serial port; REMOTE_CTRL_EN# pin 46 is one particular pin of keyboard controller 45. IRRX3 pin, SIN1_{—}5 pin, and REMOTE_CTRL_EN# pin are related to each other by connecting to switch circuit 50. Moreover, switch circuit 50 is constructed in a way that IRRX3 pin and SIN1_{—}5 pin are connected (short-circuited) or disconnected (open circuited) based on the logical state (digit 0 or digit 1) of REMOTE_CTRL_EN# pin. The logical state of REMOTE_CTRL_EN# pin of keyboard controller 45 is under control of an application program installed on laptop computer 31.

According to the preferred embodiment of present invention, IR signals received by IR receiver 33 can always be transmitted to the FIR port. Yet of the IR signals transmitted to the FIR port, only FIR signals can be properly decoded and processed by the CPU through the FIR port because the CPU cannot decode and process CIR signals through FIR port. In other words, whereas FIR signals received by IR receiver 33 are directly transmitted to the FIR port for decoding, whether CIR signals received by IR receiver 33 can be properly decoded and processed by the CPU depends on whether or not CIR signals can be transmitted to serial port 43 and through which properly received and processed by the CPU.

When the application program, by manipulating keyboard controller 45, connects or short-circuits IRRX3 pin and SIN1_{—}5 pin through switch circuit 50, CIR control signals received by IR receiver 33 are thus channeled through IRRX3 pin and SIN1_{—}5 pin to serial port of the CPU for further processing. Due to the fact that serial port 43 can be configured into different modes for different functions, for CPU to receive and process CIR signals through serial port 43 the application program sets SIN1_{—}5 pin in the mode of reception of CIR signals before connecting IRRX3 pin and SIN1_{—}5 pin.

On the other hand, when the application program, by manipulating keyboard controller 45, disconnects or open-circuits IRRX3 pin and SIN1_{—}5 pin through switch circuit 50, CIR control signals received by IR receiver 33 are thus not to be channeled through IRRX3 pin and SIN1_{—}5 pin to serial port 43 of the CPU, and are thereby not to be decoded and processed by the CPU for the reason that the CPU can only receive and properly decode CIR signals via serial port. Under such circumstance, only FIR signals received by IR receiver 33 can through FIR port be transmitted to, and be decoded and further processed by, the CPU.

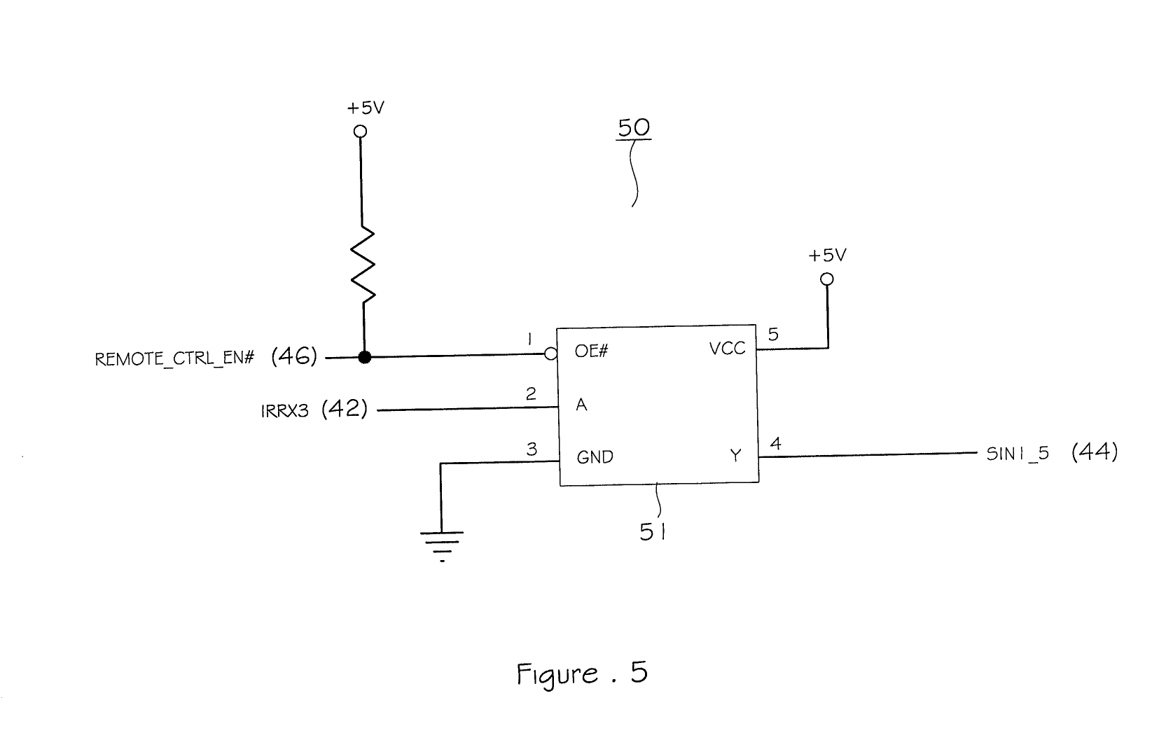

FIG. 5 illustrates the switch circuit diagram according to the present invention. Switch circuit 50 comprises mainly a five-pin logic control unit 51, wherein A pin and Y pin can be short-circuited or open-circuited according to the voltage level (high or low, i.e., digit 0 or digit 1) of EN# pin. As shown in the diagram, EN# pin is connected to REMOTE_CTRL_EN# pin of keyboard controller 45, A pin connected to IRRX3 pin of the FIR port, and Y pin to SIN1_{—}5 pin of serial port 43. Therefore, with logic control unit 51, the application program is able to connect or disconnect IRRX3 pin of the FIR port to SIN1_{—}5 pin of serial port 43 by altering the voltage level or logical state of REMOTE_CTRL_EN# pin of keyboard controller 45. In one embodiment of the present invention, when the application program brings high the voltage level of REMOTE_CTRL_EN# pin of keyboard controller 45, IRRX3 pin and SIN1_{—}5 pin are short-circuited, and CIR control signals received by IR receiver 33 can accordingly be channeled through IRRX3 pin and SIN1_{—}5 pin to serial port of the CPU for further processing.

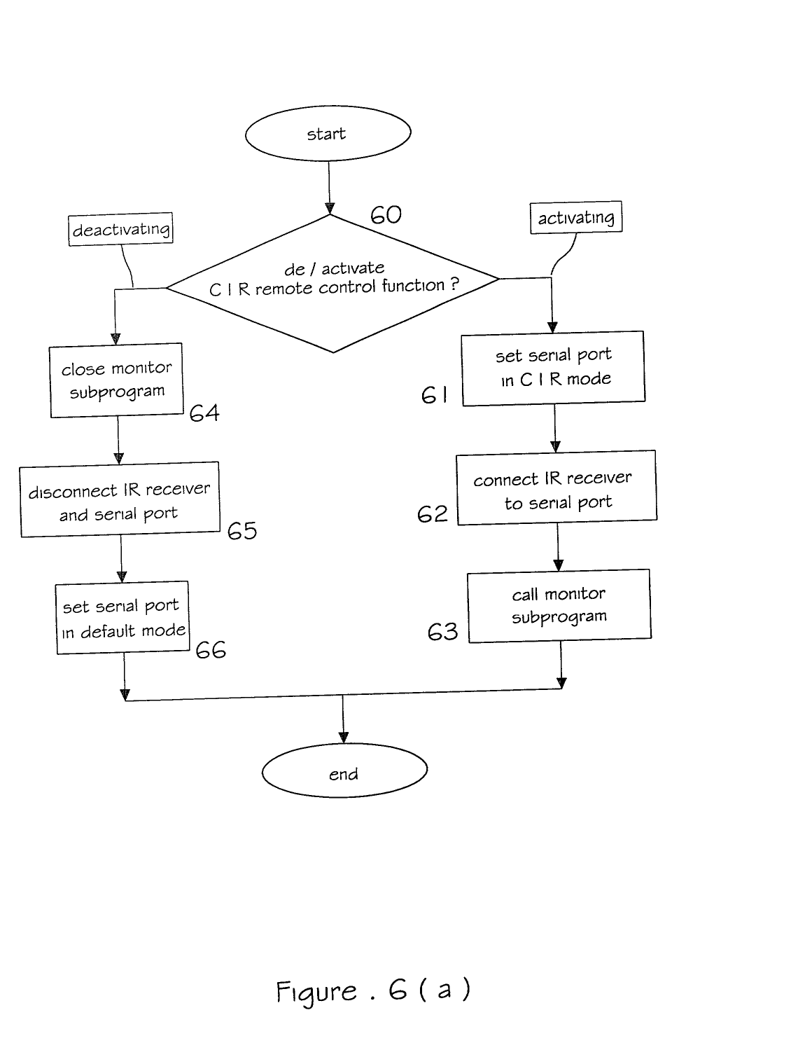

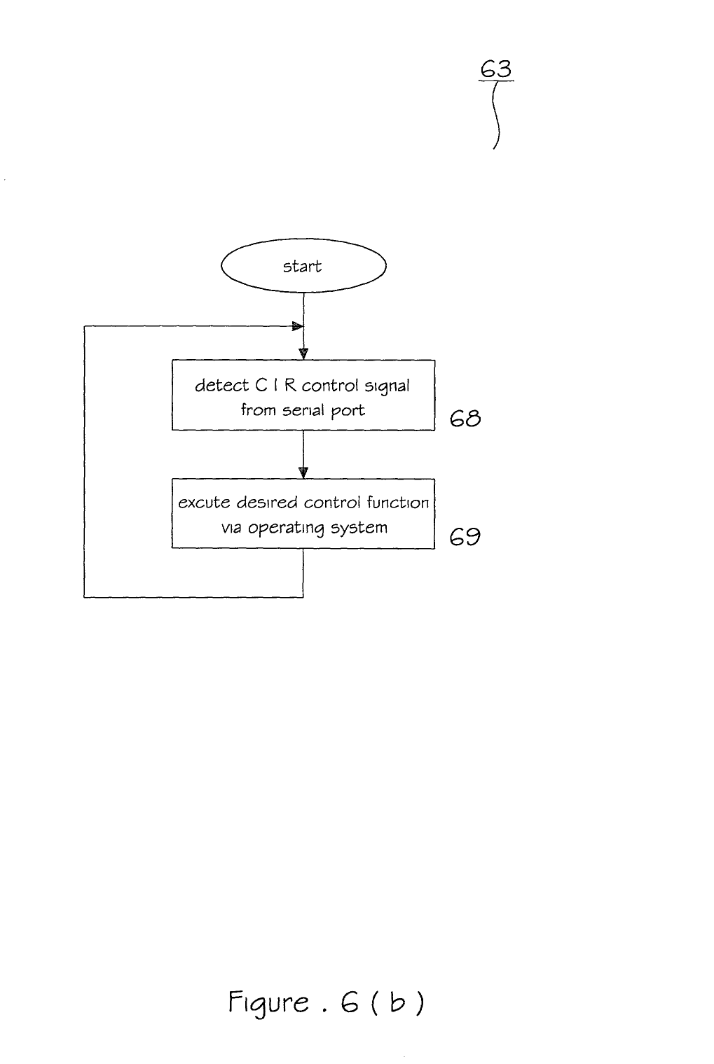

FIG. 6 illustrates a flow chart of the control software of the IR remote control system for a portable computer according to the present invention, wherein FIG. 6(a) is a flow chart of main program, and FIG. 6(b) is a monitor subprogram. First, in step 60, main program inquires the user whether the CIR remote control function is to be activated or deactivated. If the user opts for activating the CIR remote control system, main program sets SIN1_{—}5 pin in the mode of reception of CIR signals in step 61, subsequently connects IRRX3 pin to SIN1_{—}5 pin in step 62 by bringing high the voltage level of REMOTE_CTRL_EN# pin of keyboard controller 45, and finally, in step 63, calls monitor subprogram into action. Monitor subprogram performs two functions. First, in step 68, monitor subprogram detects the reception of CIR control signals from serial port after the user depresses certain control button, say, pageup, on the remote controller. Second, if CIR control signals emitted by the remote controller are detected, monitor subprogram sends to the operating system signals corresponding to the received control signals so that the desired pageup functions are executed.

On the other hand, if in step 60 the user opts for deactivating the CIR remote control system, main program immediately closes monitor subprogram in step 64, subsequently disconnects IRRX3 pin to SIN1_{—}5 pin in step 65 by bringing low the voltage level of REMOTE_CTRL_EN# pin of keyboard controller 45. Finally, main program sets SIN1_{—}5 pin of the serial port into its default mode.

Having disclosed and described the embodiment and features of present invention, it is realized that present invention contains great advantages over prior art. It is capable of receiving, and thereby being remotely controlled by, two differently-encoded IR remote control signals, namely, FIR and CIR, with only one IR receiver. By providing a control software interface, the user can easily switch between two different modes of IR signals to make adaptive and multi-functional the whole portable computer system comprising present invention.

It is to be noted that the embodiments and particular features and functions as disclosed above are for the purpose of disclosure only and are not in any sense for limiting the scope of the invention. Small modifications and juxtapositions of one or more of the functional elements anticipated by those skilled in the art without departing the spirit of present invention is to be regarded as a part of the invention.

Therefore, that the scope of present invention is determined by the appended claims is fully understood.

What is claimed is:

1. A remote control system for a portable computer with a built-in IR receiver receiving IR signals emitted from a remote controller, comprising:
chipsets connecting the central processing unit to the IR receiver and to a serial port;
a circuit switcheably connecting the IR receiver to the serial port; and
software for determining whether to switch short the circuit by transmitting a first signal to the circuit and whether to switch open the circuit by transmitting a second signal to the circuit.

2. The remote control system according to claim 1, wherein the IR receiver is connected to the central processing unit through an FIR port.

3. The remote control system according to claim 1, wherein the IR receiver receives CIR signals and FIR signals.

4. The remote control system according to claim 1, wherein the remote controller is a CIR remote controller.

5. The remote control system according to claim 1, wherein CIR signals received by the IR receiver are further transmitted to and received by the central processing unit through the serial port when the software switches short the circuit connecting the IR receiver to the serial port by transmitting the first signal to the circuit.

6. The remote control system according to claim 1, wherein the software, before switching short the circuit connecting the IR receiver to the serial port by transmitting the first signal to the circuit, sets the serial port in a mode for receiving CIR signals.

7. The remote control system according to claim 1, wherein the software, after switching open the circuit connecting the IR receiver to the serial port by transmitting the second signal to the circuit, sets the serial port in default mode.

8. The remote control system according to claim 1, wherein the circuit switcheably connects the IR receiver to the serial port by switcheably connecting one pin of the FIR port to one pin of the serial port.

9. The remote control system according to claim 1, wherein the first signal represents a switch from digit 0 to digit 1 of a particular pin of the circuit, while the second signal represents a switch from digit 1 to digit 0 of the same pin of the circuit.

10. A remote control system for a computer with a built-in IR receiver receiving IR remote control signals, comprising:
chipsets connecting the central processing unit to the IR receiver through a FIR port and connecting the central processing unit to a serial port; and
a circuit switcheably connecting the IR receiver to the serial port;
wherein the CIR signals received by the IR receiver are transmitted to and received by the central processing unit through the serial port when the circuit is short.

11. The remote control system according to claim 10, which further comprises a CIR remote controller for emitting CIR control signals to be received by the IR receiver.

12. The remote control system according to claim 10, further comprises software for determining whether to switch short the circuit by transmitting a first signal to the circuit and whether to switch open the circuit by transmitting a second signal to the circuit.

13. The remote control system according to claim 12, wherein the software, before switching short the circuit connecting the IR receiver to the serial port by transmitting the first signal to the circuit, sets the serial port in a mode for receiving CIR signals.

14. The remote control system according to claim 12, wherein the software, after switching open the circuit connecting the IR receiver to the serial port by transmitting the second signal to the circuit, sets the serial port in default mode.

15. The remote control system according to claim 12, wherein the first signal represents a switch from digit 0 to digit 1 of a particular pin of the circuit, while the second signal represents a switch from digit 1 to digit 0 of the same pin of the circuit.

16. The remote control system according to claim 10, wherein the circuit switcheably connects the IR receiver to the serial port by switcheably connecting one pin of the FIR port to one pin of the serial port.

17. The remote control system according to claim 10, wherein the CIR control signals control the pageup and pagedown functions of the computer.

18. The remote control system according to claim 10, wherein the computer is a laptop computer.

19. The remote control system according to claim 10, wherein the computer is a portable electronics device.
